(19) United States
(12) Patent Application Publication
(10) Pub. No.: US 2005/0147472 A1
(43) Pub. Date: Jul. 7, 2005

(54) Disposal of accumulated waste solids from processing of titanium-bearing ores

(76) Inventor: Samuel R. Alexander, Columbus, MS (US)

Correspondence Address: William B. Miller;Kerr-McGee Corporation, 123 Robert S. Kerr Avenue, Oklahoma City, OK, 73102, US

(21) Appl. No.: 10/746,644

(22) Filed: Dec. 29, 2003

(51) Int. Cl. B09B 3/00

(52) U.S. Cl. 405/129.2

(57) ABSTRACT

A process for treating neutralized waste solids from the processing of titanium-bearing ores, whereby the neutralized waste solids are contacted with an acid under conditions effective to dissolve at least some of the waste solids, and then residual undissolved solids are separated out prior to injection of the remainder into a subterranean waste disposal well. The process is particularly adapted to disposal of hazardous metal waste solids which have been deposited over time in a waste disposal pond but which are judged as posing a hazard for migration from the pond to surface and subterranean waters.

### FIELD OF THE INVENTION

The present invention relates to methods for protecting surface and subterreanean waters against accumulated waste solids from the industrial processing of titanium-bearing ores, for example, in the manufacture of titanium dioxide or titanium metal. More particularly, the present invention relates to methods for protecting such waters, especially subterranean drinking water sources, against the movement (or migration) of hazardous metal solid wastes produced in the industrial processing of titanium-bearing ores to such waters from a pond into which sludges containing these solids have been deposited over time.

### BACKGROUND OF THE INVENTION

In the processing of titanium-bearing ores to recover the titanium values therein in the form of titanium metal or in the form of titanium dioxide, in particular via a chloride process which produces titanium tetrachloride as an intermediate, significant quantities of impurity metal chlorides are produced. These materials, which predominantly comprise iron chloride salts, must currently be isolated or removed and then are either further processed into a salable product, for example, by roasting the byproduct iron chloride salts to produce iron oxide salable to some extent for various uses, or are disposed of in some manner. Generally a sizable percentage of the byproduct materials have been disposed of over the years, and as time has passed and higher grade, lower impurity ores have become more scarce and more expensive to employ, it has become increasingly important for manufacturers to find effective means for disposing of these wastes.

Typically disposal of the waste metal chlorides from a chloride route titanium dioxide process, for example, has been accomplished by one or more of four techniques: 1) neutralization and storage of the resulting neutralized sludge in a pond; 2) neutralization, followed by filtration and then landfilling of the filter cake; 3) open ocean disposal of the non-neutralized waste metal chloride solutions; or 4) injection of the non-neutralized waste metal chloride solutions into porous subsurface formations (safely isolated from subterranean drinking water sources) via deep well injection.

Use of a storage pond or a landfill is potentially problematic in the long run from an environmental perspective, and particularly is this so where unlined ponds have been used to contain the waste metal hydroxides in question, yet significant quantities of neutralized sludge have over the years been placed in such ponds and these represent a potential hazard for migration of the waste metal hydroxides to surface and subsurface waters including subterranean drinking water sources (all of which for convenience hereafter will collectively be termed as “groundwater’).

Dealing with the potential hazard posed by these accumulated waste solids from the processing of titanium-bearing ores under such circumstances conventionally would require that the ponded sludges be removed from the pond, for example, by dredging, then pumped and temporarily securely stored while a liner system is repaired or put into place, or removed from the pond, filtered to a sufficient degree to permit landfilling or removed from the pond and transferred to a more secure (from migration) pond. All of these options are costly, however.

### SUMMARY OF THE INVENTION

The present invention concerns a process for treating neutralized waste solids from the processing of titanium-bearing ores, whereby the neutralized waste solids are contacted with an acid under conditions effective to dissolve at least some of the waste solids and then residual undissolved solids are separated out, prior to injecting the remainder into a subterranean waste disposal well. In a particular aspect, the process is applied to neutralized waste solids which have accumulated in a waste disposal pond, whereby the neutralized waste solids are removed from the pond, contacted with an acid under conditions effective to dissolve at least some of the waste solids recovered from the pond, undissolved solids are separated out and the remainder is injected into a subterranean waste disposal well.

### BRIEF DESCRIPTION OF THE DRAWING

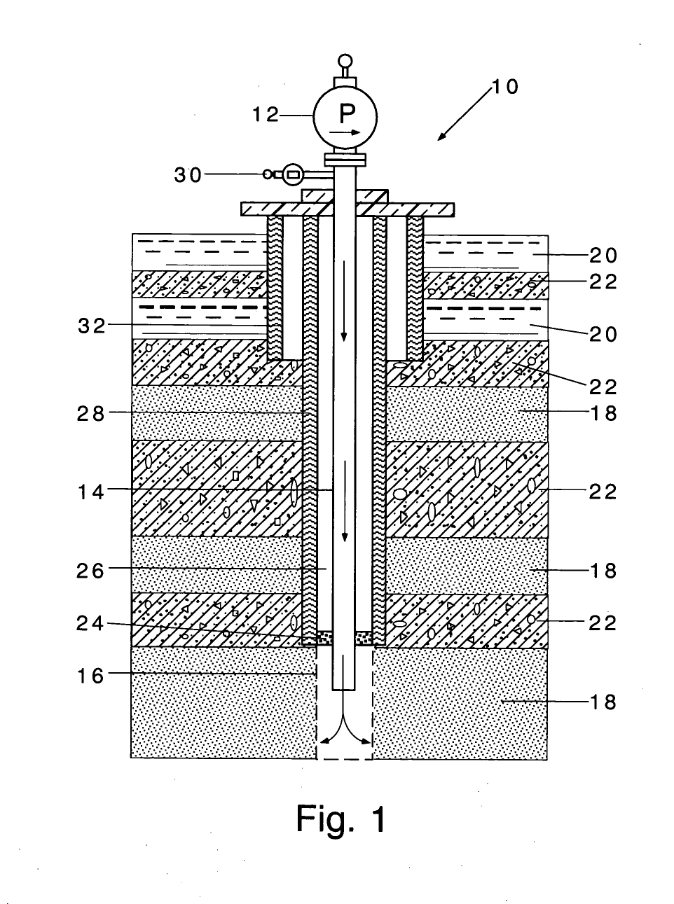

The present invention is more particularly understood by reference to the accompanying FIG. 1, which provides a schematic of an illustrative subterranean waste disposal well suited to receive the dissolved waste solids from the process of the present invention.

### DETAILED DESCRIPTION OF PREFERRED EMBODIMENTS OF THE INVENTION

Referring now to FIG. 1, a subterranean waste disposal well 10 is illustrated. The construction and principles of operation of such wells are generally well-known to those skilled in the art, but a very brief description will be undertaken nevertheless for ensuring that the invention is well-understood.

Accordingly, the well 10 receives liquid wastes including the dissolved waste solids produced by the process of the present invention by means of the injection pump 12. Pump 12 pumps the wastes through the injection tubing 14 into an injection zone defined by perforated casing 16, at which point the wastes enter into and fill a subterranean formation 18 which is permeable to fluids by means of interconnected pores or voids in the formation rock, typically being comprised of materials such as sandstone, shale and/or limestone. The wastes in formation 18 are safely isolated from drinking water sources 20 by preferably several intervening layers or confining zones 22 which are substantially impermeable to any upward migration of liquid wastes from within the formation 18, so that there is no reasonable possibility of contamination of any of the drinking water sources 20 by means of such upward migration.

Preferably the injection tubing 14 is set on a packer 24 to prevent backflow of the wastes in the annulus 26 between the injection tubing 14 and long string casing 28, and the packer 24 is isolated and monitored for leaks, for example by means of an annulus pressure gauge 30. Further, the drinking water sources 20 are protected from the wastes in injection tubing 14 and from any wastes that might leak into the annulus 26 over time by means of the surface casing 32 and by cementing on the outside of both the surface casing 32 and long string casing 28.

The process of the present invention involves the removal, dissolution and injection into the well 10 of accumulated neutralized waste solids from the processing of titanium-bearing ores, in particular those solids which have been accumulated in ponds in the vicinity of surface and subterranean waters. The dissolution is accomplished by contacting the waste solids with an acid under conditions effective to dissolve at least some of the waste solids recovered from the pond, and then undissolved solids are preferably separated out prior to injection of the remainder into the well 10.

A preferred embodiment of the process will involve dredging accumulated waste metal hydroxides resulting from the manufacture of titanium dioxide by the chloride route and the neutralization of the waste metal chlorides produced therein, from a waste disposal pond wherein such materials have been deposited. The waste solids recovered in this manner are then contacted with byproduct hydrochloric acid from the same chloride route titanium dioxide manufacturing process, typically having a concentration of about 25 percent of HCl, for a time and at a temperature sufficient preferably to dissolve all or substantially all of the waste metal solids that would be considered as hazardous wastes. Residual undissolved solids, preferably comprising only unreacted ore and coke which had been carried through the titanium dioxide manufacturing process and which can be recycled to such process, together with other materials which may be recovered and sold or put to some beneficial use, are preferably separated from the dissolved materials in solution by filtration or other known, conventional means. The now-dissolved waste solids are then injected into the well 10 as described above, whether directly or following the combination of the liquid bearing such dissolved wastes with another liquid suited for injection into the well 10.

### EXAMPLE 1

Approximately 1 kilogram (1000.3 grams) of pond sludge was taken from a waste disposal pond for waste solids from a chloride process titanium dioxide manufacturing plant. The sludge sample was combined with 25 weight percent hydrochloric acid at room temperature, whereupon 98 percent of the solids in the sample were observed as going into solution. The mixture was then filtered and x-ray fluorescence analyses performed on both the filtrate and the residual solids.

The filtrate composition is shown in Table 1, while the residual solids analysis is reported in Table 2:

TABLE 1
Filtrate Composition

| Metal | Mg/Liter of Filtrate |
|---|---|
| Aluminum | 1690 |
| Chromium | 330 |
| Iron | 11500 |
| Magnesium | 3800 |
| Manganese | 760 |
| Sodium | 460 |
| Phosphorus | 110 |
| Sulfur | 1100 |
| Vanadium | 720 |

TABLE 2
Residual Solids

| Constituent | Percent by Weight |
|---|---|
| TiO2 | 29.0 |
| Al2O3 | 0.4 |
| SiO2 | 12.5 |
| MgO | 0.4 |
| Fe2O3 | 0.6 |
| CaO | 1.0 |
| Carbon | 56.1 |

1. A process for treating neutralized waste solids from the processing of titanium-bearing ores, whereby the neutralized waste solids are contacted with an acid under conditions effective to dissolve at least some of the waste solids, residual undissolved solids are separated out and the remainder is injected into a subterranean waste disposal well.

2. A process as defined in claim 1, wherein the neutralized waste solids are from a process of making titanium dioxide from titanium-bearing ores by chlorination of the titanium values to titanium tetrachloride followed by oxidization of the titanium tetrachloride to titanium dioxide.

3. A process as defined in claim 1, wherein the neutralized waste solids are from a process of making titanium metal through a titanium tetrachloride intermediate.

4. A process for disposing of accumulated neutralized waste solids from a process of making titanium dioxide from titanium-bearing ore by chlorination of the titanium values in the ore to titanium tetrachloride followed by oxidization of the titanium tetrachloride to titanium dioxide, whereby the neutralized waste solids are removed from a waste disposal pond wherein the solids have been deposited over time, contacted with an acid under conditions effective to dissolve at least some of the waste solids recovered from the pond, undissolved solids are separated out and the remainder is injected into a subterranean waste disposal well.

5. A process as defined in claim 4, wherein the acid used is a by-product hydrochloric acid from the titanium dioxide manufacturing process.

6. A process as defined in claim 4, wherein substantially all of the hazardous metal waste solids are dissolved with the acid and injected into the subterranean waste disposal well.

7. A process as defined in claim 4, wherein unreacted ore, coke or both are recovered as undissolved solids and recycled to the titanium dioxide manufacturing process.
